(19) United States
(12) Patent Application Publication
(10) Pub. No.: US 2019/0346886 A1
(43) Pub. Date: Nov. 14, 2019

(54) INFORMATION PROCESSING DEVICE AND HOUSING

(71) Applicant: FUJITSU CLIENT COMPUTING LIMITED, Kanagawa (JP)

(72) Inventor: Akio Yoshida, Kawasaki (JP)

(73) Assignee: FUJITSU CLIENT COMPUTING LIMITED, Kanagawa (JP)

(21) Appl. No.: 16/522,833

(22) Filed: Jul. 26, 2019

Related U.S. Application Data
(63) Continuation of application No. PCT/JP2018/002974, filed on Jan. 30, 2018.

(30) Foreign Application Priority Data
Apr. 5, 2017 (JP) 2017-075469

(51) Int. Cl. G06F 1/16; G02F 1/1333

(52) U.S. Cl. CPC G06F 1/1643; G06F 1/1626; G02F 2001/133314; G06F 1/1635; G02F 1/133308

(57) ABSTRACT

An information processing device according to an embodiment includes: a housing that includes: a plate-like element including a support face with a recess; and a support that is disposed opposite an opening of the recess and that supports the plate-like element. The recess includes a slit. The slit and the support partially overlap each other in a plan view of the support face in a normal direction.

### CROSS-REFERENCE TO RELATED APPLICATIONS

This application is a continuation of PCT International Application No. PCT/JP2018/002974 filed on Jan. 30, 2018, which designates the United States and claims the benefit of priority from Japanese Patent Application No. 2017-075469 filed on Apr. 5, 2017, the entire contents of which are incorporated herein by reference.

### FIELD

This disclosure relates generally to an information processing device and a housing.

### BACKGROUND

Liquid crystal display (LCD) units represent a display component of an information processing device such as a personal computer (PC). A liquid crystal display unit includes a liquid crystal glass substrate formed of a liquid crystal layer of several microns placed in-between two sheets of glass. The liquid crystal layer is subdivided into areas by partitions, and each area contains the same amount of liquid crystal. The liquid crystal glass substrate may be subject to an intensive load, which may cause damage of the liquid crystal layer.

Examples of an information processing device include a tablet PC containing a substrate and a battery on the back side of a display surface of an LCD unit. There is a step between the substrate and the battery due to a shorter distance from the LCD unit to the battery than from the LCD unit to the substrate. The LCD unit may be pressed down from the display surface side and deformed in the boundary to the substrate and the battery. In such a case, the liquid crystal layer in the deformed part of the LCD unit is likely to be damaged.

In view of this, a cover is placed between the LCD unit and the substrate to resolve the step between the substrate and the battery. In order to prevent the cover between the LCD unit and the substrate from bending, a support is provided to support the end of the cover. When pressed down from the display surface side, the LCD unit contacts the cover. Then, part of a contact region between the LCD unit and the cover above the support receives a larger load than the rest of the contact region. This is likely to cause damage of the liquid crystal layer of the LCD unit in the contact region between the LCD unit and the cover above the support.

### SUMMARY

According to one aspect of this disclosure, in general, an information processing device includes a housing which includes a plate-like element including a support face with a recess, and a support that is located opposite an opening of the recess and supports the plate-like element, wherein the recess is provided with a slit, and the slit and the support at least partially overlap each other in a plan view of the support face in a normal direction.

### BRIEF DESCRIPTION OF THE DRAWINGS

FIG. 1 is a perspective view of an exemplary structure of an information processing device according to an embodiment;

FIGS. 2A and 2B are perspective views of the exterior of the information processing device;

FIG. 3A is a plan view of a housing, FIG. 3B is a cross-sectional view of the housing in FIG. 3A along a dashed-dotted line A1-A2, and FIG. 3C is a cross-sectional view of the housing in FIG. 3A along a dotted line B1-B2;

FIG. 4A is an enlarged cross-sectional view of a region C1 of the housing in FIG. 3B indicated by a solid circle;

FIG. 4B is an enlarged cross-sectional view of a region D1 of the housing indicated by a solid circle in FIG. 3C;

FIGS. 5A and 5B are plan views of an M-cover, and FIG. 5B is an enlarged view of a region H1 indicated by a solid circle in FIG. 5A;

FIG. 6A is an enlarged cross-sectional view of a region F1 of the housing indicated by a dotted rectangle in FIG. 4A;

FIG. 6B is an enlarged cross-sectional view of a region G1 of the housing indicated by a dotted rectangle in FIG. 4B;

FIG. 6C is a plan view of a region E1 indicated by a solid circle in FIG. 3A;

FIG. 6D is a perspective view of the region E1 indicated by a solid circle in FIG. 3A;

FIG. 7A is a perspective view of a B-cover, FIG. 7B is a perspective sectional view of the B-cover, and FIG. 7C is a cross-sectional view of the B-cover;

FIG. 8A illustrates a result of analysis of the pressure applied to an LCD unit according to the embodiment, and FIG. 8B is a plan view of a housing;

FIG. 9A illustrates a result of analysis of the pressure applied to the LCD unit according to the embodiment, and FIG. 9B is a plan view of a housing;

FIG. 10A illustrates a result of analysis of the pressure applied to an LCD unit of an exemplary tablet terminal device for comparison, and FIG. 10B is a plan view of an M-cover and a B-cover;

FIG. 11A illustrates a result of analysis of the pressure applied to the LCD unit of the tablet terminal device for comparison, and FIG. 11B is a plan view of the M-cover and the B-cover;

FIG. 12A is a plan view of an M-cover, FIG. 12B is a perspective view of the M-cover, and FIG. 12C is a perspective sectional view of the M-cover along a dotted line N1-N2 in FIG. 12B;

FIGS. 13A and 13B are plan views of a B-cover;

FIG. 14A is a cross-sectional view of the B-cover along a dotted line P1-P2 in FIG. 13B, and FIG. 14B is an enlarged view of a region M1 indicated by a dotted rectangle in FIG. 14A;

FIGS. 15A and 15B are cross-sectional views of the tablet terminal device for comparison; and

FIG. 16 is a cross-sectional view of the tablet terminal device for comparison.

### DETAILED DESCRIPTION

Hereinafter, exemplary embodiments will be described in detail with reference to the accompanying drawings. Configurations of the following embodiments are merely exemplary, and are unintended to limit the features of this disclosure.

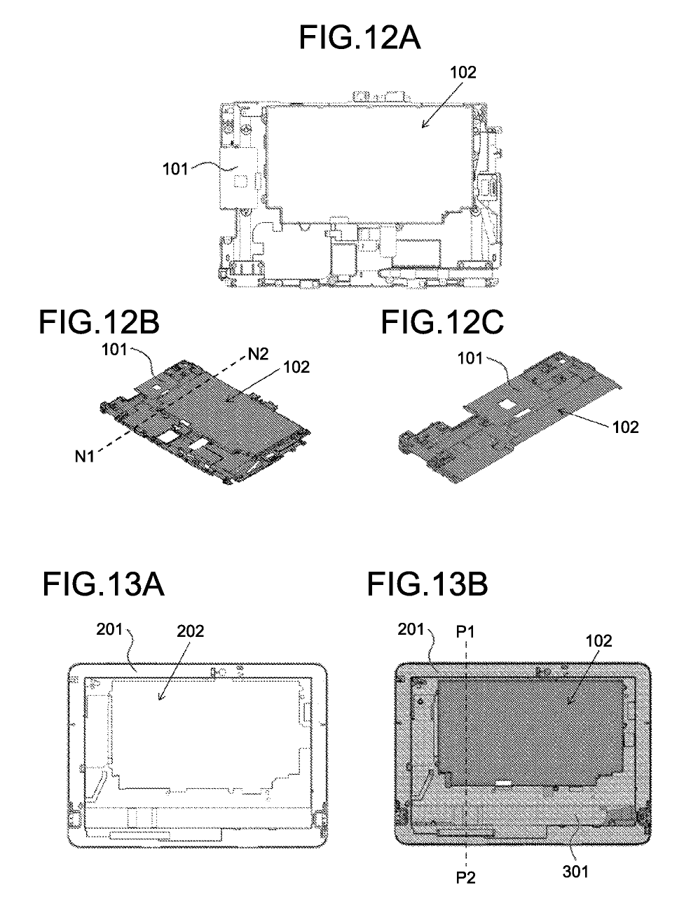

A tablet terminal device for comparison will be described with reference to FIGS. 12 to 16. As illustrated in FIGS. 12A to 12C, a tablet terminal device represents an information processing device as an example, and adopts a structure including an M-cover 101 with a box-shaped recess 102 in which a battery is accommodated. FIG. 12A is a plan view of the M-cover 101, FIG. 12B is a perspective view of the M-cover 101, and FIG. 12C is a perspective sectional view of the M-cover 101 along a dotted line N1-N2 in FIG. 12B. The tablet terminal device further includes, as illustrated in FIG. 13A, a B-cover 201 adjacent to the back face of an LCD unit. The B-cover 201 is provided with an opening 202. As illustrated in FIG. 13B, the back side of the recess 102 of the M-cover 101 (protruding as viewed from the B-cover 201) is fitted into the opening 202 of the B-cover 201. The tablet terminal device includes a substrate 301 between the M-cover 101 and the B-cover 201. Electronic components are mounted on the substrate 301. FIG. 13A is a plan view of the B-cover 201, and FIG. 13B is a plan view of the B-cover 201 with the back side of the recess 102 of the M-cover 101 fitted into the opening 202 of the B-cover 201.

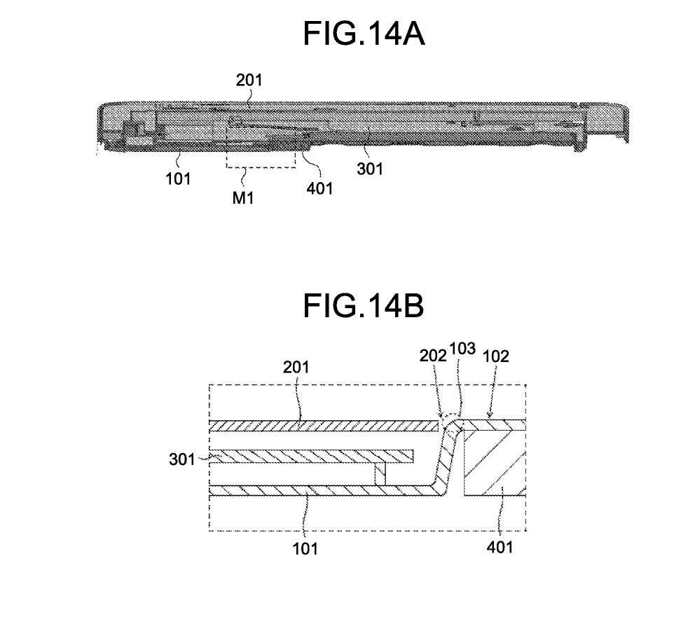

As illustrated in FIGS. 14A and 14B, the M-cover 101 is provided with the recess 102 for accommodating a battery 401, and a corner 103 of the recess 102 of the M-cover 101 is directed toward the LCD unit. FIG. 14A is a cross-sectional view of the B-cover 201 along a dotted line P1-P2 in FIG. 13B. FIG. 14B is an enlarged view of a region M1 indicated by a dotted rectangle in FIG. 14A. The back side of the recess 102 of the M-cover 101 is fitted into the opening 202 of the B-cover 201. That is, the B-cover 201 has a cantilever structure with the periphery of the opening 202 forming an open end.

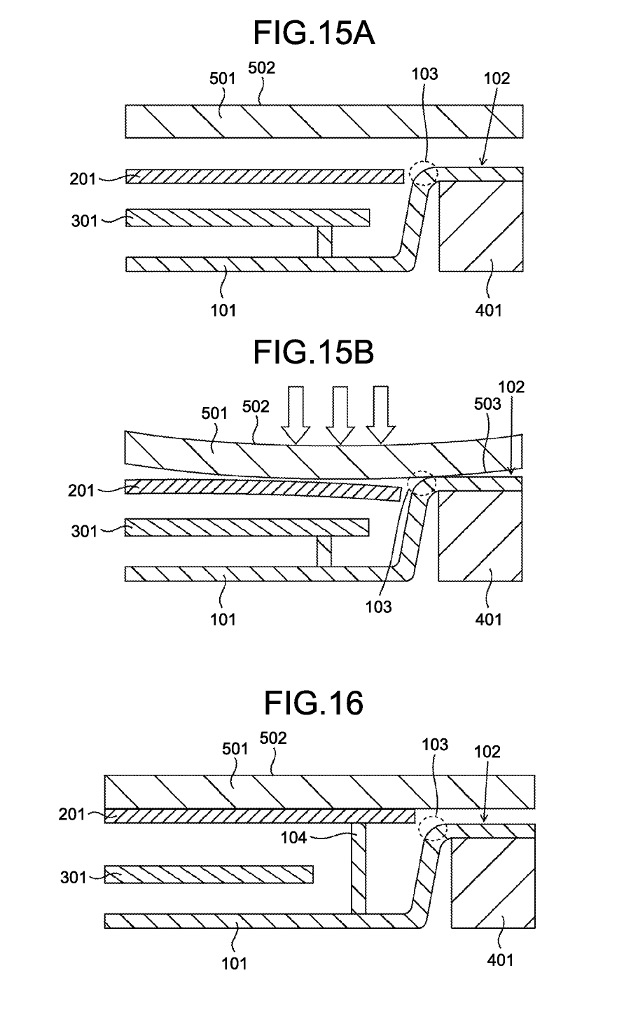

As illustrated in FIG. 15A, an LCD unit 501 is placed on or above the B-cover 201. As illustrated in FIG. 15B, a back face 503 of the LCD unit 501, when pressed from a display surface 502 side, is likely to come into line contact or point contact with the corner 103 of the recess 102 of the M-cover 101. FIGS. 15A and 15B are cross-sectional views of the tablet terminal device for comparison. A pressing force applied to the display surface 502 of the LCD unit 501 causes great stress on a contact position between the corner 103 and the LCD unit 501 (hereinafter referred to as the contact position of the LCD unit 501), which may damage a liquid crystal layer of the LCD unit 501. By covering the back face 503 of the LCD unit 501 with a sheet metal, the liquid crystal layer of the LCD unit 501 can be prevented from being damaged. However, in response to demands for a thinner LCD unit 501, the back face of the LCD unit 501a is no longer covered with a sheet metal, so that the liquid crystal layer of the LCD unit 501 can be damaged.

For example, possible measures therefor are such that a buffer material may be attached to the corner 103 of the recess 102 of the M-cover 101 to prevent stress concentration on the contact position of the LCD unit 501. However, the buffer material attached to the corner 103 of the recess 102 of the M-cover 101 creates a step between the M-cover 101 and the B-cover 201, which may result in another stress concentration on the LCD unit 501 and damaging the liquid crystal layer of the LCD unit 501. To avoid occurrence of the step between the M-cover 101 and the B-cover 201, a buffer material may be attached to the entire back side of the recess 102 of the M-cover 101. This, however, increases the area of the buffer material, leading to increases in weight and cost of the tablet terminal device.

Referring to FIG. 16, for example, the B-cover 201 is higher in position than the back side of the recess 102 of the M-cover 101 and a support member 104 is provided to support the open end of the B-cover 201. By receiving pressure from the display surface 502 of the LCD unit 501 illustrated in FIG. 16, the B-cover 201 contacts the LCD unit 501, so that the corner 103 is prevented from contacting the LCD unit 501. By a pressing force onto the display surface 502 of the LCD unit 501, however, an intensive load is transmitted from the support member 104 to the LCD unit 501, which may damage the liquid crystal layer of the LCD unit 501.

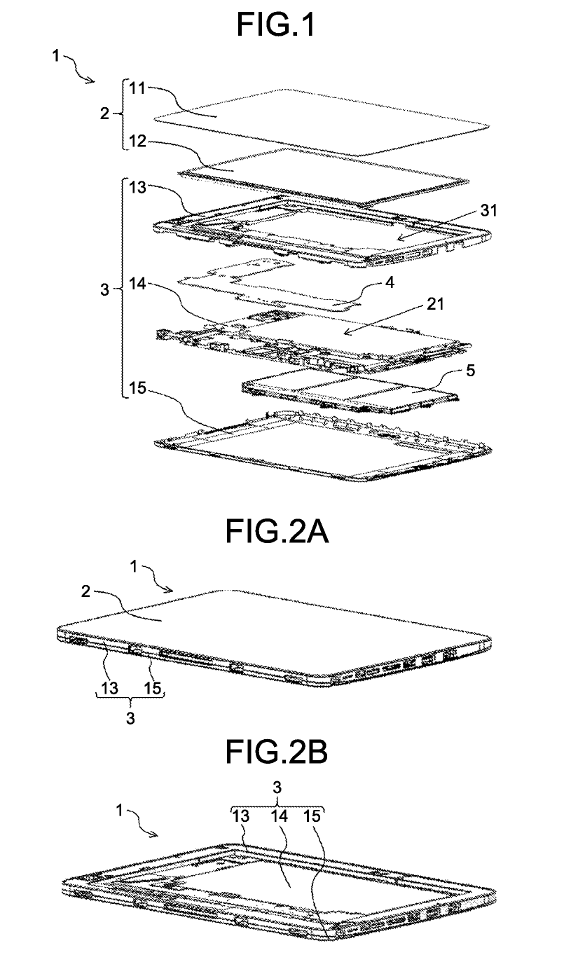

FIG. 1 is a perspective view of an exemplary structure of an information processing device 1 according to an embodiment. The information processing device 1 includes a display device 2 including a touch panel 11 and an LCD unit 12, a housing 3 including a B-cover 13, an M-cover 14, and an A-cover 15, a substrate 4, and a battery 5. Examples of the information processing device 1 include a tablet terminal device, a smartphone, a tablet personal computer, an electronic notebook, a personal digital assistance (PDA), and an electronic book. The housing 3 houses the substrate 4 and the battery 5. The substrate 4 represents a circuit board on which electronic components such as a central processing unit (CPU), a random access memory (RAM), and a read only memory (ROM) are mounted. The battery 5 supplies power to the substrate 4 and other electronic components. A touch operation to the surface of the touch panel 11 with a finger or a pen, for example, is detected. The LCD unit 12 includes a liquid crystal layer placed in-between two sheets of glass and displays an image by applying a voltage to the liquid crystal layer to change the direction of liquid crystal molecules and adjust optical transmittance.

The B-cover 13 is a plate-like member and is located adjacent to the back face of the LCD unit 12. The back face of the LCD unit 12 is opposite to a front face or a light emitting face of the LCD unit 12. The B-cover 13 is an exemplary plate-like element. The M-cover 14 is provided with a recess 21 in which the battery 5 is accommodated. The back side of the recess 21 (protrusion as viewed from the B-cover 13) of the M-cover 14 protrudes to fit into an opening 31 of the B-cover 13. The A-cover 15 covers the battery 5 contained in the recess 21 of the M-cover 14. FIGS. 2A and 2B are perspective views of the exterior of the information processing device 1. FIG. 2A illustrates the information processing device 1 with the display device 2 attached to the housing 3. FIG. 2B illustrates the information processing device 1 with the display device 2 detached from the housing 3.

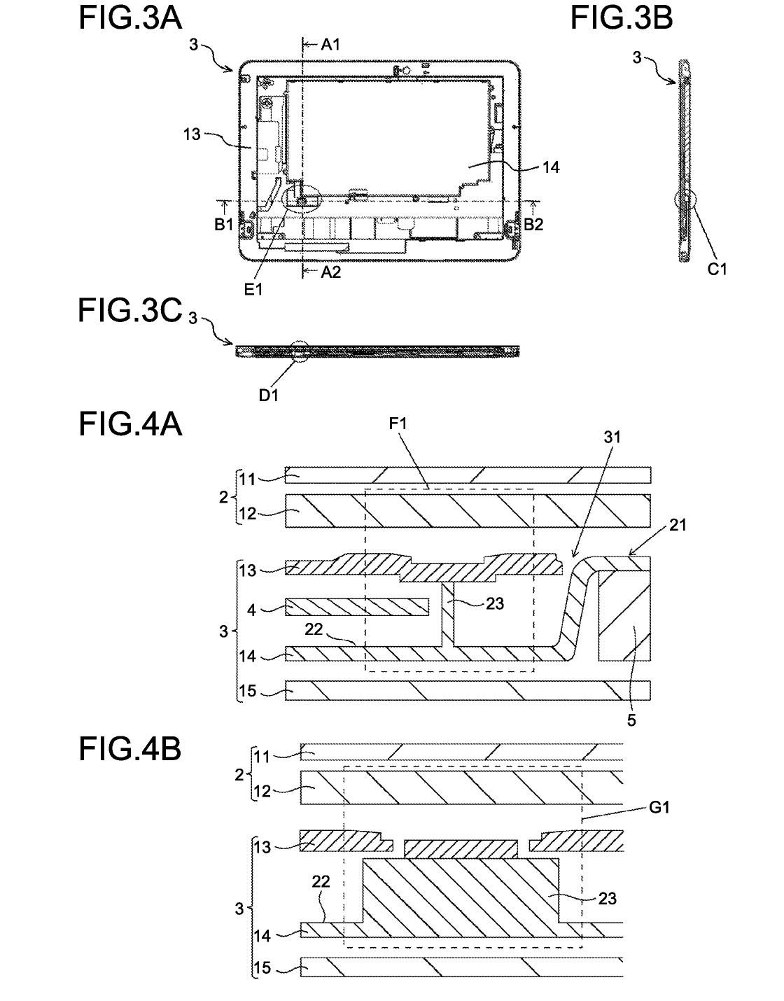

FIG. 3A is a plan view of the housing 3, FIG. 3B is a cross-sectional view along a dashed-dotted line A1-A2 in FIG. 3A, and FIG. 3C is a cross-sectional view along a dotted line B1-B2 in FIG. 3A. FIG. 4A is an enlarged cross-sectional view of a region Cl of the housing 3 indicated by a solid circle in FIG. 3B. FIG. 4B is an enlarged cross-sectional view of a region D1 of the housing 3 indicated by a solid circle in FIG. 3C. FIGS. 4A and 4B illustrate the housing 3 to which the display device 2 is attached. As illustrated in FIGS. 4A and 4B, the M-cover 14 is provided with a rib 23 on a top face 22. The top face 22 of the M-cover 14 faces the display device 2. The rib 23 works to support the B-cover 13. The rib 23 is an exemplary support. The rib 23 is placed between the B-cover 13 and the M-cover 14 in order to prevent the B-cover 13 from bending. The M-cover 14 may be provided with a plurality of ribs 23 on the top face 22. The M-cover 14 and the rib 23 may be integrated together or the rib 23 may be separable from the M-cover 14.

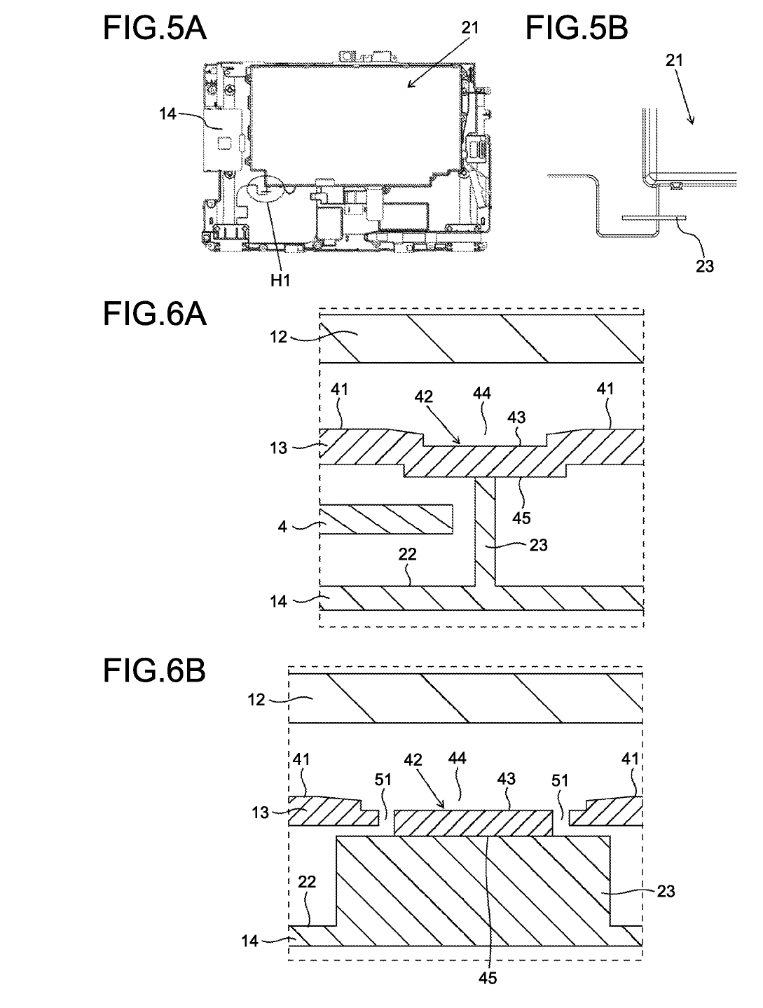

The location of the rib 23 may be optionally set on the top face 22 of the M-cover 14. For example, the rib 23 may be located in the vicinity of the recess 21 of the M-cover 14. FIGS. 5A and 5B are plan views of the M-cover 14, and FIG. 5B is an enlarged view of a region H1 indicated by a solid circle in FIG. 5A. In FIGS. 5A and 5B, the rib 23 is located in the vicinity of the recess 21 of the M-cover 14 by way of example. The B-cover 13 is provided with the opening 31 into which the back side of the recess 21 of the M-cover 14 is to be fitted. Thus, as illustrated in FIG. 4A, the B-cover 13 has a cantilever structure with the periphery of the opening 31 forming an open end. The rib 23 located adjacent to the opening 31 works to restrict the open end of the B-cover 13 from bending.

Alternatively, for example, the rib 23 may be located around the corner of the back side of the recess 21 of the M-cover 14 (hereinafter also referred to as the corner of the M-cover 14) which is the location in the LCD unit 12 where a load concentration is likely to occur. In the case that the LCD unit 12 is pressed down from the display device 2 side and the open end of the B-cover 13 becomes lower in position than the corner of the M-cover 14, the corner of the M-cover 14 intensively hits against the LCD unit 12. By placing the rib 23 around the corner of the M-cover 14 which is the location in the LCD unit 12 where a load concentration is likely to occur, the corner of the M-cover 14 is avoided from intensively hitting against the LCD unit 12.

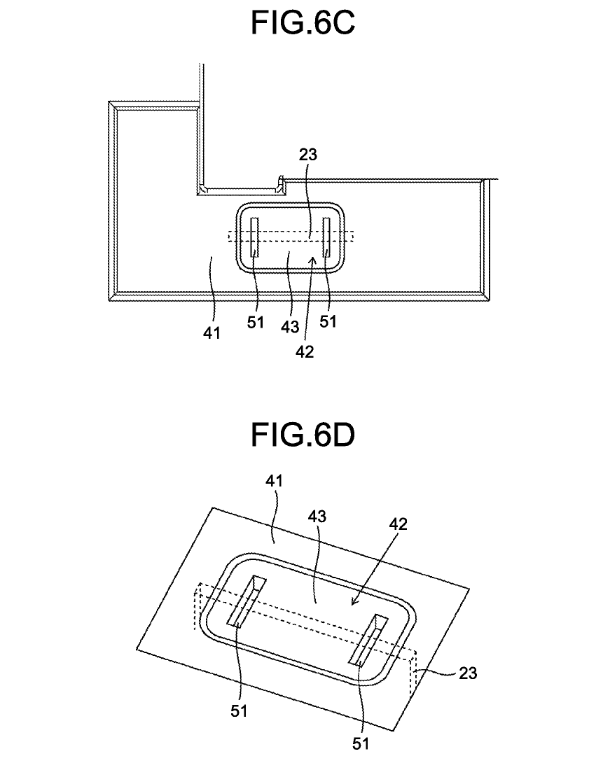

FIG. 6A is an enlarged cross-sectional view of a region F1 of the housing 3 indicated by a dotted rectangle in FIG. 4A. FIG. 6B is an enlarged cross-sectional view of a region G1 of the housing 3 indicated by a dotted rectangle in FIG. 4B. FIG. 6C is a plan view of a region E1 indicated by a solid circle in FIG. 3A. FIG. 6D is a perspective view of the region E1 indicated by a solid circle in FIG. 3A. The B-cover 13 includes a support face 41 with a recess 42. The support face 41 supports the LCD unit 12 while pressed down from the display device 2 side. The support face 41 is flat. A bottom face 43 of the recess 42 is lower in position than the support face 41. In a plan view of the support face 41 in the normal direction, the bottom face 43 of the recess 42 may be rectangular, circular, elliptic, triangular, or polygonal having five or more sides. The bottom face 43 of the recess 42 may have an R-shaped corner in a plan view of the support face 41 in the normal direction.

The support face 41 and the bottom face 43 of the recess 42 face in the same direction, opposing the back face of the LCD unit 12. The rib 23 is located opposite an opening 44 of the recess 42, and is in contact with a back face 45 of the recess 42. The back face 45 of the recess 42 is opposite to the bottom face 43 of the recess 42 and opposes the top face 22 of the M-cover 14. A top face or a head of the rib 23 having a cubic shape, for example, contacts the back face 45 of the recess 42. By contact with the back face 45 of the recess 42, the rib 23 supports the B-cover 13. The back face 45 of the recess 42 is flat, however, it may be appropriately machined in accordance with the shape of the rib 23.

The bottom face 43 of the recess 42 is lower in position than the support face 41. Thus, there is a longer distance between the back face of the LCD unit 12 and the bottom face 43 of the recess 42 than between the back face of the LCD unit 12 and the support face 41. While the LCD unit 12 is pressed down from the display device 2 side to contact the B-cover 13, the back face of the LCD unit 12 does not contact the bottom face 43 of the recess 42, or the back face of the LCD unit 12 contacts the support face 41 rather than the bottom face 43 of the recess 42. As illustrated in FIG. 6A, there may be a step between the support face 41 and the bottom face 43 of the recess 42. However, the shape of the recess 42 is not limited to the one illustrated in FIG. 6A. The housing 3 may include an inclined face between the support face 41 and the bottom face 43 of the recess 42. The bottom face 43 of the recess 42 may be flat or curved. The bottom face 43 of the recess 42 may be inclined with respect to the support face 41. The recess 42 may have a box shape. The recess 42 may have a substantially V-shaped cross section and a flat back face 45. There may be a step between the opposite side of the support face 41 and the back face 45 of the recess 42, or the opposite side of the support face 41 and the back face 45 of the recess 42 may be at the same height.

The recess 42 is located above the rib 23 with the back face 45 of the recess 42 in contact with the rib 23. The LCD unit 12 may contact the support face 41 and apply a load to the B-cover 13. In such a case, stress concentration occurs on a concave ridge line of the recess 42, i.e., the outer periphery of the bottom face 43 of the recess 42. The support face 41 or the bottom face 43 of the recess 42 is not subjected to stress concentration, that is, the LCD unit 12 evenly receives a load without a greater load applied on part of the LCD unit 12 than the rest. Thus, a load concentration on part of the LCD unit 12 is prevented, which leads to prevent the liquid crystal layer of the LCD unit 12 from being damaged.

The recess 42 is provided with slits 51. By the slits 51, the recess 42 or the concave ridge line of the recess 42 is easily deformable in response to a load applied from the LCD unit 12 to the B-cover 13. Thereby, stress concentration on the concave ridge line of the recess 42 can be reduced. The contact region of the recess 42 with the rib 23 is, however, not easily deformable by a load applied from the LCD unit 12 to the B-cover 13. In view of this, by at least partially overlapping the rib 23 with the slits 51 in a plan view of the support face 41 in the normal direction, the contact region of the recess 42 with the rib 23 is made deformable by a load from the LCD unit 12 to the B-cover 13. It is preferable to place the slits 51 near the concave ridge line of the recess 42 in view of stress concentration on the concave ridge line. Moreover, as illustrated in FIG. 6B, it is preferable for the outer part of the slits 51 in the B-cover 13 not to contact with the rib 23.

In a plan view of the support face 41 in the normal direction, the overlapping part of the outer periphery of the bottom face 43 (concave ridge line) of the recess 42 with the rib 23 is not easily deformable. Thus, the slits 51 may be located near or around the overlapping part of the outer periphery of the bottom face 43 in a plan view of the support face 41 in the normal direction. Alternatively, the slits 51 may be located adjacent to the overlapping part of the outer periphery of the bottom face 43 of the recess 42 in a plan view of the support face 41 in the normal direction.

The following describes a rectangular bottom face 43 of the recess 42 in a plan view of the support face 41 in the normal direction by way of example. In this case, the B-cover 13 is provided with the recess 42 such that the long sides of the rectangle are parallel to the open end of the B-cover 13. This can enlarge the area where a load on the LCD unit 12 is abated. As for the rectangular bottom face 43 of the recess 42, the short sides of the rectangle are smaller in deformability than the long sides. In other words, the short sides of the rectangular bottom face 43 of the recess 42 are less bendable than the long sides. This may lead to a load concentration on part of the LCD unit 12. In view of this, the recess 42 with the rectangular bottom face 43 is provided with the slits 51 parallel to the short sides of the rectangular bottom face 43. The slits 51 are located in parallel to the short side of the rectangular bottom face 43. This arrangement makes the short sides of the bottom face 43 of the recess 42 easily deformable in response to a load applied from the LCD unit 12 to the B-cover 13. Thereby, stress concentration on the short sides of the bottom face 43 of the recess 42 can be reduced. The recess 42 may be provided with two or three or more slits 51. With the recess 42 located in the B-cover 13 in the extending direction of the rib 23, the short sides of the rectangular bottom face 43 are orthogonal to the rib 23 and the slits 51 are orthogonal to the rib 23 in a plan view of the support face 41 in the normal direction.

The number of the slits 51 is optional. The recess 42 may be provided with one or more slits 51. The slit 51 may penetrate through the recess 42. In other words, the slit 51 may be a through hole from the bottom face 43 to the back face 45 of the recess 42. In addition, the slit 51 may not penetrate through the recess 42 but end inside the recess 42. For example, the slit 51 may be a groove that is recessed from the bottom face 43 toward the back face 45 of the recess 42 and open to the bottom face 43 of the recess 42. For example, the slit 51 may be a groove that is recessed from the back face 45 toward the bottom face 43 of the recess 42 and has an opening on the back face 45 of the recess 42. By the slit 51 being a through hole, the recess 42 or the concave ridge line of the recess 42 is further easily deformable in response to a load applied from the LCD unit 12 to the B-cover 13, thereby further abating stress concentration on the concave ridge line of the recess 42.

The rib 23 can be optionally set in terms of length and width. The length and width of the rib 23 may be set with reference to the top face 22 of the M-cover 14 or the bottom face 43 of the recess 42 in a plan view in the normal direction. The bottom face 43 of the recess 42 can be optionally set in terms of length and width. The length and width of the bottom face 43 of the recess 42 may be set with reference to the top face 22 of the M-cover 14 or the bottom face 43 of the recess 42 in a plan view in the normal direction. The rib 23 may be longer in length than the bottom face 43 of the recess 42. The rib 23 may be the same in length as the bottom face 43 of the recess 42. The rib 23 may be shorter in length than the bottom face 43 of the recess 42.

It is preferable that the support face 41 of the B-cover 13 be higher in position than the corner of the M-cover 14. In such a case, the back face of the LCD unit 12, when pressed down from the display device 2 side, first contacts the support face 41 of the B-cover 13. This restricts a load from being applied onto the LCD unit 12 from the corner of the M-cover 14. Thus, a load concentration on part of the LCD unit 12 can be prevented, thereby preventing the liquid crystal layer of the LCD unit 12 from being damaged.

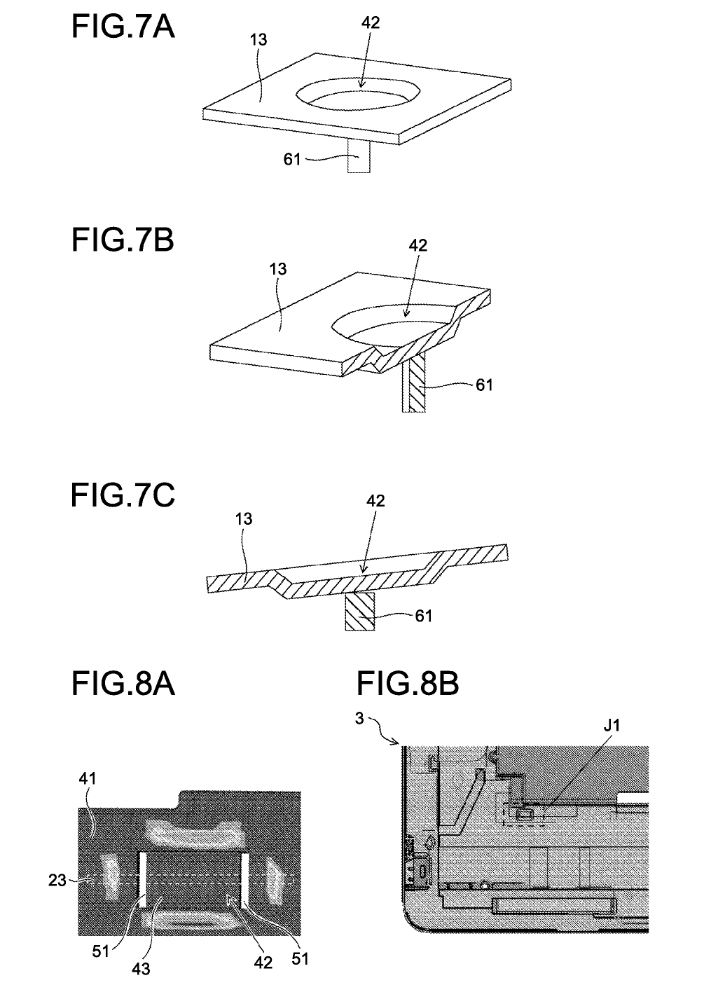

As illustrated in FIGS. 7A to 7C, for example, the back face 45 of the recess 42 can be supported by a thin rod-like projection 61. In this case the B-cover 13 may move unstably at the projection 61 as a fulcrum in a seesaw-like manner. FIG. 7A is a perspective view of the B-cover 13, FIG. 7B is a perspective sectional view of the B-cover 13, and FIG. 7C is a cross-sectional view of the B-cover 13. In this case, if the B-cover 13 is inclined, the support face 41 of the B-cover 13 comes lower in position than the corner of the M-cover 14. Thus, the LCD unit 12, when pressed down from the display device 2 side, hits against the corner of the M-cover 14. It is thus preferable for the rib 23 to have a shape and a size not to cause a tilt of the B-cover 13.

The above embodiment has described, but is not limited to, the B-cover 13 and the M-cover 14 as separate components by way of example. The B-cover 13 and the M-cover 14 may be united. The united B-cover 13 and M-cover 14 may be integrated with the rib 23.

Analysis Result

The following describes a result of analysis for the information processing device 1 according to the embodiment. A certain load was applied from the display device 2 side to the LCD unit 12 for the purpose of analyzing pressure applied to the LCD unit 12. FIG. 8A illustrates a result of the analysis of pressure onto the LCD unit 12 according to the embodiment, depicting a pressure distribution in a region J1 indicated by a dotted rectangle in FIG. 8B. FIG. 8B is a plan view of the housing 3. The bottom face 43 of the recess 42 is rectangular, and the recess 42 is provided with the slits 51 parallel to the short sides of the rectangle. As illustrated in FIG. 8A, pressure concentration occurred not on the support face 41 or the bottom face 43 of the recess 42 but on the concave ridge line of the recess 42. A maximum value of pressure applied to the LCD unit 12 was set to 100 as a reference of an analysis result in the embodiment and each comparison. In addition, a certain load was applied to the LCD unit 12 from the housing 3 side to analyze pressure applied to the LCD unit 12, and similar results were obtained.

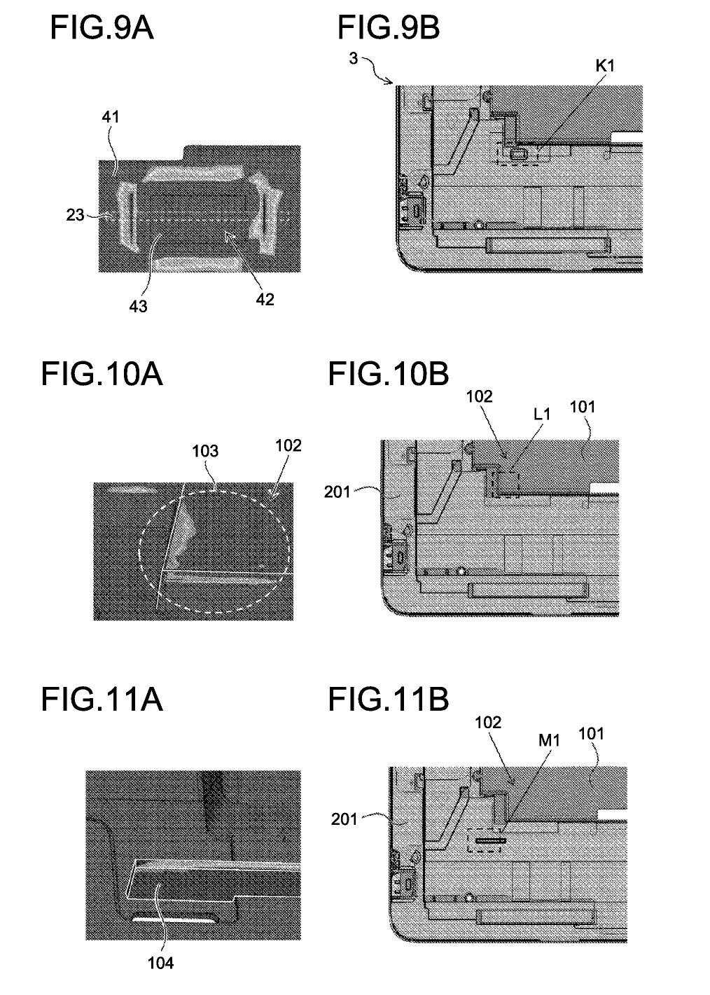

FIG. 9A illustrates another result of the analysis of pressure applied to the LCD unit 12 according to the embodiment, depicting a pressure distribution in a region K1 indicated by a dotted rectangle in FIG. 9B. FIG. 9B is a plan view of the housing 3. The bottom face 43 of the recess 42 is rectangular, and the recess 42 is provided with no slits 51. As illustrated in FIG. 9A, pressure concentration occurred not on the support face 41 or the bottom face 43 of the recess 42 but on the concave ridge line of the recess 42. However, as compared with the recess 42 with the slits 51, stress concentrated on the short sides of the rectangular bottom face 43 of the recess 42. The maximum value of pressure applied to the LCD unit 12 was 134. In addition, a certain load was applied to the LCD unit 12 from the housing 3 side to analyze pressure applied to the LCD unit 12, and similar results were obtained. The analysis results can confirm that the slits 51 of the recess 42 work to abate pressure concentration on the concave ridge line of the recess 42.

The following describes a result of the analysis for the comparative tablet terminal device. A certain load was applied to the LCD unit 501 from the display surface 502 side to analyze pressure applied to the LCD unit 501. FIG. 10A illustrates a result of the analysis of pressure applied to the LCD unit 501 of the tablet terminal device for comparison in FIGS. 15A and 15B, depicting a pressure distribution in a region L1 indicated by a dotted rectangle in FIG. 10B. FIG. 10B is a plan view of the M-cover 101 and the B-cover 201. As illustrated in FIG. 10A, pressure concentration occurred on the corner 103 of the recess 102 of the M-cover 101. The analysis result illustrated in FIG. 10A can show that the LCD unit 501 intensively hits against the corner 103 of the recess 102 of the M-cover 101. A maximum value of pressure applied to the LCD unit 501 was 162, which will be likely to damage the liquid crystal layer of the LCD unit 501. Further, a certain load was applied to the LCD unit 501 from the M-cover 101 side to analyze pressure applied to the LCD unit 501. Similar results were obtained.

FIG. 11A illustrates another result of the analysis of pressure applied to the LCD unit 501 of the tablet terminal device for comparison in FIG. 16, depicting a pressure distribution in the region M1 indicated by a dotted rectangle in FIG. 11B. FIG. 11B is a plan view of the M-cover 101 and the B-cover 201. As illustrated in FIG. 11A, pressure concentration occurred on the support member 104. The analysis result illustrated in FIG. 11A can confirm that the LCD unit 501 intensively hits against the open end of the B-cover 201 on the support member 104. The maximum value of pressure applied to the LCD unit 501 was 136, which will be likely to damage the liquid crystal layer of the LCD unit 501. Further, a certain load was applied to the LCD unit 501 from the M-cover 101 side to analyze pressure applied to the LCD unit 501. Similar results were obtained.

The analysis results can confirm that the information processing device 1 according to the embodiment is improved in pressure resistance by about 38%, in comparison with the tablet terminal device for comparison in FIGS. 15A and 15B. In addition, the analysis result can confirm that the information processing device 1 according to the embodiment is improved in pressure resistance by about 27%, as compared with the tablet terminal device for comparison in FIG. 16. The information processing device 1 according to the embodiment can be improved in pressure resistance with no inclusion of a buffer material. Thus, the information processing device 1 according to the embodiment can achieve cost reduction and weight reduction, as compared with the one additionally including a buffer material for improvement of pressure resistance.

According to one aspect of this disclosure, as to an intended object placed on the surface of a support, it is possible to prevent a greater load from acting on a contact region of the object with the support surface than on the rest of the object.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An information processing device comprising:
a housing comprising:
a plate-like element including a support face with a recess; and
a support that is disposed opposite an opening of the recess and that supports the plate-like element, wherein
the recess comprises a slit, and
the slit and the support partially overlap each other in a plan view of the support face in a normal direction.

2. The information processing device according to claim 1, wherein
the recess includes a rectangular bottom face,
the rectangular bottom face has a short side that is orthogonal to the support, and
the slit is disposed in parallel with the short side of the rectangular bottom face.

3. The information processing device according to claim 1, wherein the slit penetrates through the recess.

4. A housing comprising:
a plate-like element that includes a support face with a recess; and
a support that is disposed opposite an opening of the recess and that supports the plate-like element, wherein
the recess comprises a slit, and
the slit and the support partially overlap each other in a plan view of the support face in a normal direction.
